(19) United States
(12) Patent Application Publication
(10) Pub. No.: US 2025/0390315 A1
(43) Pub. Date: Dec. 25, 2025

(54) EVENT-DRIVEN ARCHITECTURE FOR USER INTERFACE BADGES

(71) Applicant: Wells Fargo Bank, N.A., San Francisco, CA (US)

(72) Inventors: Peter Rozovski, Concord, CA (US); Ameena Mubeen, Fremont, CA (US); Daniel Goldvekht, Millbrae, CA (US); Venkata Ramireddy Dornala, Fremont, CA (US)

(21) Appl. No.: 18/747,891

(22) Filed: Jun. 19, 2024

(51) Int. Cl. G06F 9/451; G06F 3/0481

(52) U.S. Cl. CPC G06F 9/451; G06F 3/0481

(57) ABSTRACT

Systems and techniques for are described herein. A data change event is received that is related to account activity of a user in a computer application. The data change event is logged in an event table stored within a transactional database. The data change event is processed to determine an updated count related to a UI badge. A message is sent that contains the updated count from a batch process to a message broker. The message broker distributes the message to a real-time database system. The updated count is transmitted from the real-time database system to a user interface. The user interface displays the UI badge. The updated count is displayed in real-time on the UI badge.

### TECHNICAL FIELD

Embodiments described herein generally relate to user interface status indicators and, in some embodiments, more specifically to event-driven architecture for triggering and updating user interface badges.

### BACKGROUND

User interface (UI) badges are graphical elements within a user interface that provide quick visual notifications to inform a user about new or outstanding tasks or items that are available to be explored or completed. The badges may display numeric indicators showing counts of items such as unread messages, pending notifications, or due actions. For example, in a context of a bill pay system, badges may alert users about unread billing notices and upcoming or overdue payments. Conventional badge update mechanisms may utilize a service-oriented architecture that may update badges upon login and at a polling interval.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment and a system for, according to an embodiment.

FIG. 2 illustrates a block diagram of an example of topology component to process a count event for an application using, according to an embodiment.

FIG. 3 illustrates a block diagram of an example of retry topology component to process a count event for an application using, according to an embodiment.

FIG. 4 is a flow diagram of an example of a method for, according to an embodiment.

FIG. 5 is a block diagram illustrating an example of a machine upon which one or more embodiments may be implemented.

### DETAILED DESCRIPTION

In a traditional service-oriented architecture (SOA), updates to the user interface (UI) (e.g., a count of unread notices, due payments, badges, etc.) make multiple service calls. The multiple service calls may result in tens of millions of web-service calls daily, as each user action queries the backend to refresh the data. In an example of a bill payment application a badging feature implemented in classical SOA, may result in tens of millions of service calls for each badge. For example, two badges in SOA in the bill payment application result in more than fifty million web-service calls to refresh numbers in badges. That is additional network traffic, additional web-service calls, additional load for database, etc. resulting in usage of unnecessary hardware. The high volume of requests leads to increased network traffic, higher loads on the database, and excessive consumption of server resources, which can slow down a computing system and increase operational costs. The technical solution discussed herein uses an event-driven model with an architecture the reduces continuous polling of backend system components to update UI elements. Instead, updates are driven by events that signify actual changes in data. This approach reduces the number of service calls because events are generated when there are actual changes to data. For example, a badge element in a user interface may be updated when a bill has been paid, a notice has been read, etc. The reduction in service calls decreases network traffic and server load, enhancing overall system performance and reducing costs.

The polling mechanism in SOA introduces latency because the system periodically checks for updates. Users might not see real-time updates on their interfaces because the updates depend on the polling interval. The latency can degrade user experience, especially in environments where real-time data is critical for decision-making, such as in financial transactions. The technical solution discussed herein uses a distributed event streaming platform (DESP) (e.g., APACHE® KAFKA®, etc.) as a message broker to allow for immediate propagation of events across the system. When an event occurs, it is published to the DESP, and interested services (e.g., subscribed services, the UI, etc.) are notified in real-time. The use of the DESP in the solution ensures that the UI reflects changes almost instantaneously without waiting for the next polling cycle improving the user experience by providing up-to-date information to enable quicker responses to changes. The technical solution architecture leverages a specialized unstructured database setup (e.g., using MONGODB®, etc.) is used to store and quickly retrieve the latest state needed for UI updates, reducing frequency of resource-intensive queries to a primary transactional database. This architecture speeds up data retrieval and optimizes the use of database resources, focusing on quick reads and writes to enable real-time interactions.

Scaling a system that relies heavily on synchronous service calls for updating UI components can be problematic. As the number of users grows, the volume of service calls can overwhelm the system. This scalability issue can lead to higher response times and additional server capacity to handle the load. The DESP provides built-in scalability and fault tolerance that can handle high volumes of messages and distribute them efficiently across a cluster of servers. As the system scales with more users or more frequent updates, the DESP can manage the increased load without significant changes to the underlying architecture. Its distributed nature also means that if one node fails, others can take over, ensuring continuous availability and reliability.

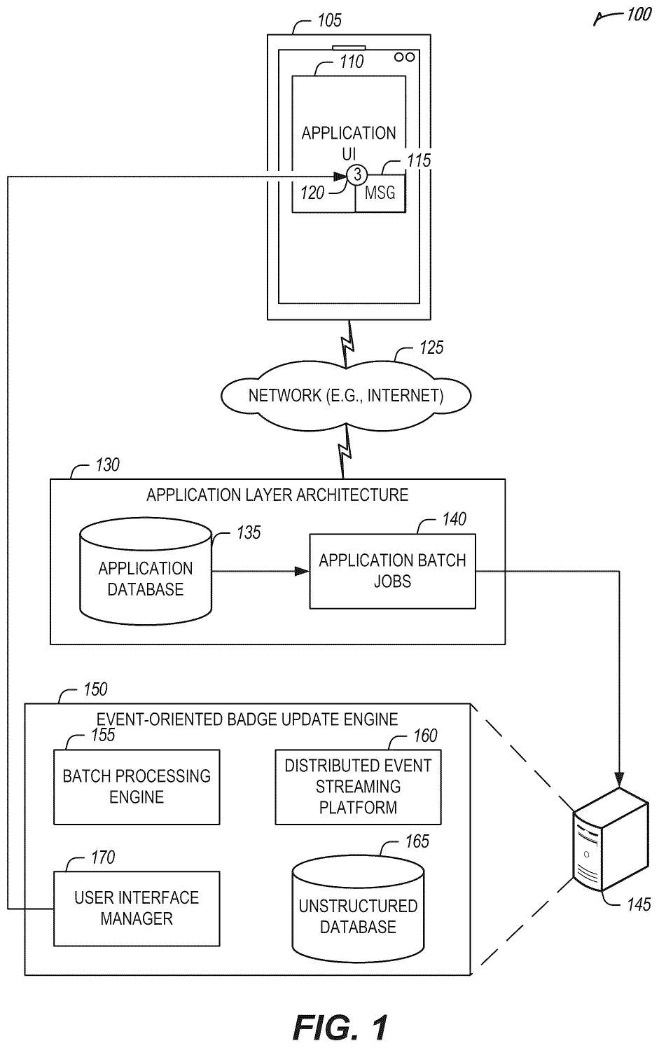

FIG. 1 is a block diagram of an example of an environment 100 and a system 150 for, according to an embodiment. The environment 100 may include a user computing device 105 (e.g., a smartphone, tablet, laptop, etc.) that may be communicatively coupled via the network 125 (e.g., the Internet, cellular network, wireless network, local area network, wide area network, metropolitan area network, nearfield communication network, wide band communication network, radio network, etc.) to an application layer architecture 130 (e.g., a delivery architecture for a bill pay application, a messaging application, etc.) via an application user interface (UI) 110 that may include a messaging feature 115 that includes a UI badge 120 for indicating notifications. The application layer architecture 130 may include a variety of components including an application database 135 (e.g., structured database, unstructured database, etc.) and application batch jobs 140. The application layer architecture 130 is communicatively coupled (e.g., using the network 125 or another network) to a server computing device 145 (e.g., a standalone server, a server cluster, a cloud computing platform, a software-as-a-service platform, etc.).

The server computing device 145 may include the system 150. In an example, the system 150 may be an event-oriented badge update engine. The system 150 may include a variety of components including a batch processing engine 155, a distributed event streaming platform (DESP) 160, a user interface (UI) manager 170, and an unstructured database 165 (e.g., MONGODB®, APACHE COUCHDB®, etc.).

The application database 135 stores data related to the application. For example, in a bill pay application, the application database 135 may store data related to bill payments, including the status of bills (e.g., paid, unpaid, etc.), and notices (e.g., unread, read, etc.). Changes in the application database 135 trigger events. For example in the bill payment application, a bill being paid or a notice being read may trigger respective events. The application database 135 may include an event table that is a special table where events are logged. Each event entry may include an event type (e.g., unread notice updated, payment made, etc.) and an ID of an impacted customer.

The application batch jobs 140 run at regular intervals (e.g., every 5 minutes, every hour, every minute, or other scheduled or random interval as appropriate). A batch job reads the events table, calculates the updated counts for each type of event, and prepares messages to be sent to the batch processing engine 155 of the system 150. The batch processing engine 155 transfers the events to the DESP 160 that acts as a messaging system that handles distribution of event messages. Messages are received from the application batch jobs 140 and forwarded to the appropriate components, such as the UI manager 170 or other services that need to react to these events.

The unstructured database 165 is a specialized database for handling real-time data updates. The unstructured database 165 stores latest counts and statuses to be displayed in the UI badge 120 via the UI manager 170, ensuring quick access and update capabilities.

The application UI 110 displays real-time information provided by the UI manager 170 to a user with focus on badges such as UI badge 120 that shows event counts (e.g., unread notices, due payments, etc.). The UI manager 170 subscribes to updates from the DESP 160 and refreshes the UI badge 120 as new data is received, ensuring that users see the most current information without manually refreshing or experiencing delays.

The DESP 160 may operate across a cluster of machines, ensuring high availability and resilience. Data may be partitioned and replicated across multiple nodes in the cluster to balance load and prevent data loss. The DESP 160 is capable of handling hundreds of thousands of messages per second, supporting the addition of nodes to the cluster without downtime to scale according to demand. The DESP 160 may store data on disk and not just in memory, providing durability. Data may be replicated across multiple nodes, which protects against hardware failures and ensures data integrity. The DESP 160 is optimized for low latency operations, making it suitable for scenarios that require real-time data processing and rapid decision-making. Stream processing capabilities are supported allowing for continuous processing of data streams to perform tasks such as aggregations, transformations, and enrichments in real-time.

When a user action or application process changes data in the application database 135 (e.g., marking a bill as paid, etc.), the change generates an event. The event is logged in the event table with specific details about what occurred and which user is affected. Periodically, the batch job scans the event table, aggregates the events, and sends updates to the DESP 160. The DESP 160 receives the updates and distributes the information to the unstructured database 165 and potentially other components subscribed to the event data stream. The UI manager 170 pulls the latest data from the unstructured database 165 or receives push updates via the DESP 160 and updates the UI badge 120 displayed to the user in the application UI 110. The user sees the updated UI badge 120 and may interact with the application based on the latest data. For example, in a bill pay application, the user may view detailed notices or confirm payments.

The system 150 including the DESP 160 decreases the number of calls to the application database 135 for updating UI components because updates are event-driven rather than time-polling. Responsiveness of the application is enhanced by using the DESP 160 and the specialized unstructured database 165 to handle real-time data efficiently. The enhancements provided by the DESP 160 and the unstructured database 165 reduce operational costs associated with data processing and server load.

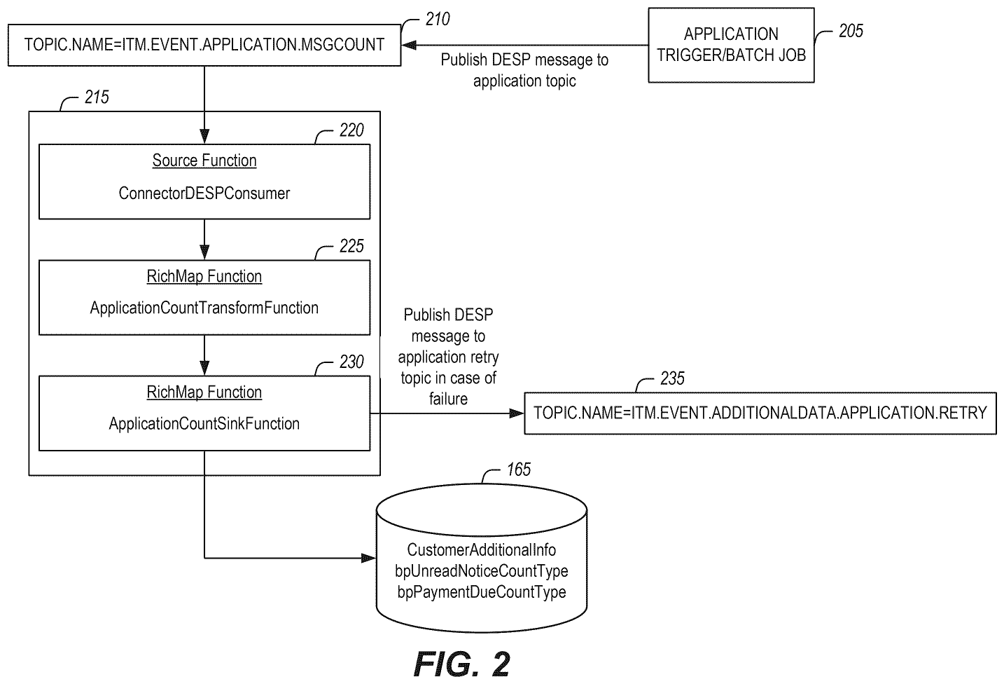

FIG. 2 illustrates a block diagram of an example of topology component 215 to process a count event for an application using, according to an embodiment. The example provided in FIG. 2 illustrates an example application trigger or batch job (e.g., from the application batch jobs 140 as described in FIG. 1, etc.) a DESP message to be published to an application topic 210. In the example, the application topic 210 is a message count topic for the application. The topology component 215 includes a source function 220 to connect a DESP data consumer to a DESP data stream, a first rich map feature that 225 provides a message count transform function for the application, and a second rich map feature 230 that provides a message count sink function for the application. If the functions of the topology component 215 fail, a DESP message is published to a retry topic 235 for the application message count. If the functions of the topology component 215 complete successfully, an entry is made in the unstructured database 165.

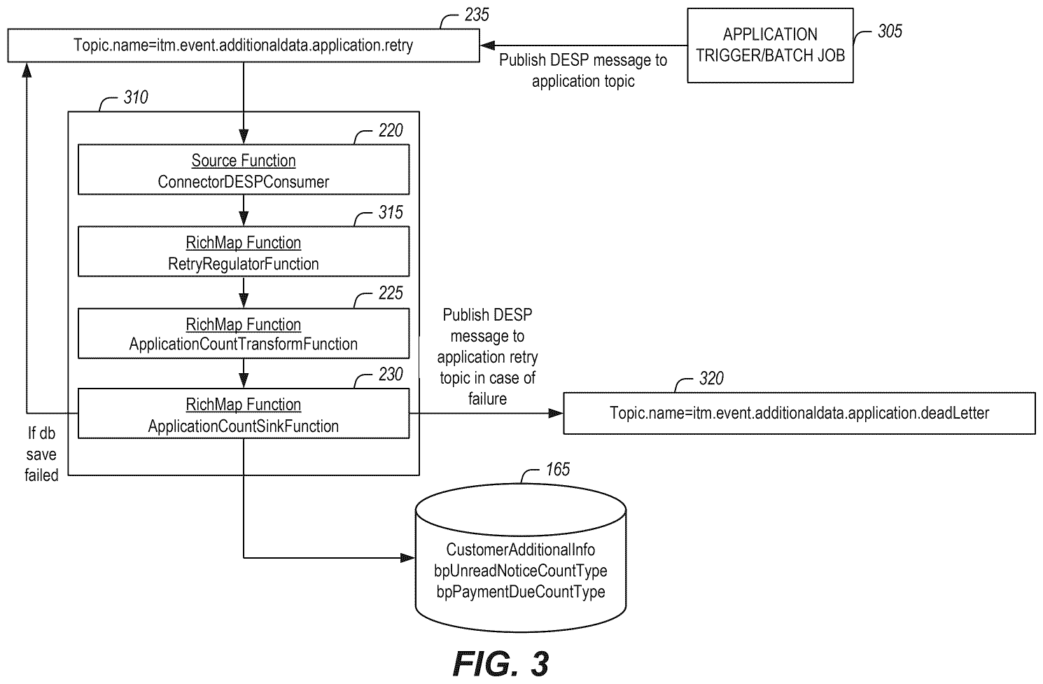

FIG. 3 illustrates a block diagram of an example of retry topology component 315 to process a count event for an application using, according to an embodiment. The example retry topology component 315 is used to avoid data loss in case of database failures. The retry topology component 315 consumes the message published by an original topology component (e.g., the topology component 215 as described in FIG. 2, etc.) to the retry topic 235 and holds the message for a period of time (e.g., 10 minutes, etc.). The data is processed with the defined operators in original topology including source function 220, first rich map function 225, and second rich map function 230. A third rich map function 315 regulates the retry process. the third rich map function 315 may use a variety of variables including a retry delay variable that defines a wait period before reprocessing the message, a maximum retry variable that defines the maximum number of time a message will be reprocessed, and a publish enabled variable that defines whether the message may be republished to the retry topic 235. For example, the maximum retry variable may be set to three and if the retry count is greater than three, a DESP message is published to a dead letter message queue 320. If the retry is successful, an entry is created in the unstructured database 165. If saving to the unstructured database 165 is unsuccessful, the retry topic 235 is reprocessed by the retry topology component 310 upon the publish enabled variable being set to true and upon expiration of the retry delay time period defined in the retry delay variable.

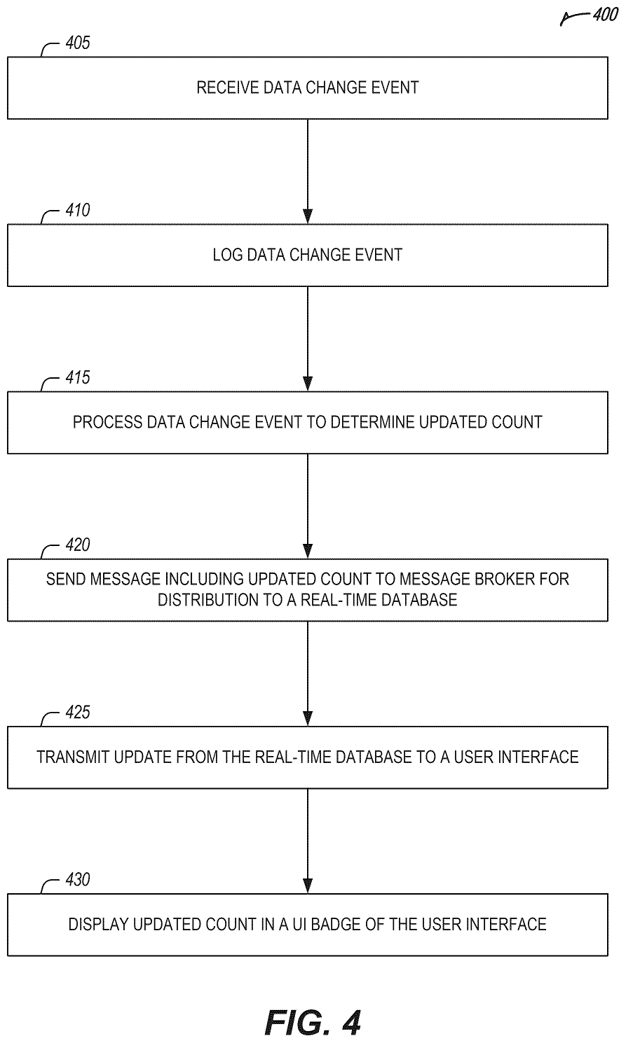

FIG. 4 is a flow diagram of an example of a method 400 for, according to an embodiment. The method 400 may provide features as described in FIGS. 1 to 3.

A data change event is received (e.g., in the application database 135 as described in FIG. 1, etc.) that is related to account activity of a user in the computer application (e.g., at operation 405). In an example, the data change event may be generated by a transactional database upon occurrence of an account activity selected from the group consisting of: a payment being made, a bill being received, a notice being read, and a notice being issued.

The data change event is logged in an event table (e.g., in the application database 165 as described in FIG. 1, etc.) stored within the transactional database (e.g., at operation 410). In an example, the event table may categorize each data change event by event type and an associated user account.

The data change event is processed (e.g., by the batch processing engine 155 as described in FIG. 1, etc.) to determine an updated count related to a UI badge (e.g., at operation 415). In an example, processing the data change event may include aggregating data change events from the event table at predetermined intervals and calculating the updated count based on the aggregated data change events. In an example, the UI badge may visually indicate to the user a number of unread notices or due payments that reflect current account activities or state.

A message containing the updated count is sent (e.g., by the batch processing engine 155 as described in FIG. 1, etc.) from a batch process to a message broker (e.g., the DESP 160 as described in FIG. 1, etc.). The message broker distributes the message to a real-time database system (e.g., at operation 420). In an example, the message broker may be configured to handle bulk volumes (e.g., high volumes, scaling volumes, etc.) of messages and distribute them across a distributed system. In an example, the real-time database system may utilize a non-relational database configured for high-speed data operations and real-time (e.g., immediate, etc.) data retrieval. In an example, security measures including data encryption and secure data channels may be used to protect the integrity and confidentiality of data transmitted between the transactional database, the message broker, and the real-time database system.

The updated count is transmitted from the real-time database system (e.g., the unstructured database 165 as described in FIG. 1, etc.) to a user interface that displays the UI badge (e.g., at operation 425). The updated count is displayed in real-time (e.g., by the UI manager 170 as described in FIG. 1, etc.) on the UI badge.

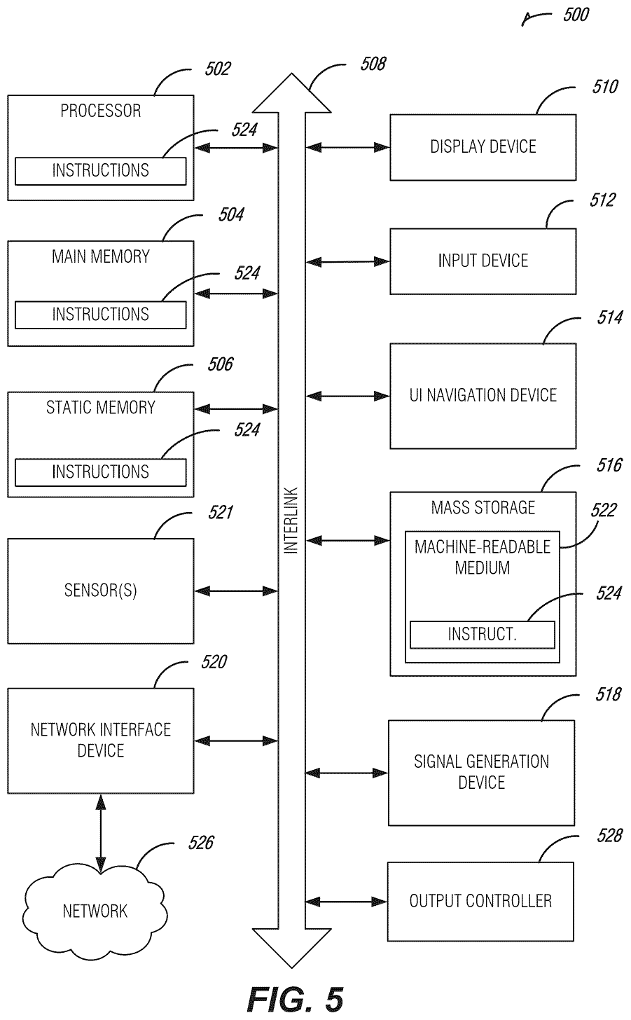

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensors. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. In an example, machine readable media may exclude transitory propagating signals (e.g., non-transitory machine-readable storage media). Specific examples of non-transitory machine-readable storage media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, LoRa®/LoRaWAN® LPWAN standards, etc.), IEEE 802.15.4 family of standards, peer-to-peer (P2P) networks, 3^{rd} Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

### Additional Notes & Examples

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for updating a user interface (UI) badge in a computer application in real-time comprising:
at least one processor; and
memory comprising instructions that, when executed by the at least one processor, cause the at least one processor to perform operations to:
receive a data change event related to account activity of a user in the computer application;
log the data change event in an event table stored within a transactional database;
process the data change event to determine an updated count related to the UI badge;
send, from a batch process to a message broker, a message containing the updated count, wherein the message broker distributes the message to a real-time database system;
transmit the updated count from the real-time database system to a user interface, wherein the user interface displays the UI badge; and
display, in real-time, the updated count on the UI badge.

2. The system of claim 1, wherein the data change event is generated by the transactional database upon occurrence of an account activity selected from the group consisting of: a payment being made, a bill being received, a notice being read, and a notice being issued.

3. The system of claim 1, wherein the event table categorizes each data change event by event type and an associated user account.

4. The system of claim 1, the instructions to process the data change event further comprising instructions that cause the at least one processor to:
aggregate data change events from the event table at predetermined intervals; and
calculate the updated count based on the aggregated data change events.

5. The system of claim 1, wherein the UI badge visually indicates to the user a number of unread notices or due payments that reflect current account state.

6. The system of claim 1, wherein the message broker is configured to handle bulk volumes of messages and distribute the messages across a distributed system.

7. The system of claim 1, wherein the real-time database system utilizes a non-relational database configured for high-speed data operations and real-time data retrieval.

8. At least one non-transitory machine-readable medium comprising instructions for updating a user interface (UI) badge in a computer application in real-time that, when executed by at least one processor, cause the at least one processor to perform operations to:
receive a data change event related to account activity of a user in the computer application;
log the data change event in an event table stored within a transactional database;
process the data change event to determine an updated count related to the UI badge;
send, from a batch process to a message broker, a message containing the updated count, wherein the message broker distributes the message to a real-time database system;
transmit the updated count from the real-time database system to a user interface, wherein the user interface displays the UI badge; and
display, in real-time, the updated count on the UI badge.

9. The at least one non-transitory machine-readable medium of claim 8, wherein the data change event is generated by the transactional database upon occurrence of an account activity selected from the group consisting of: a payment being made, a bill being received, a notice being read, and a notice being issued.

10. The at least one non-transitory machine-readable medium of claim 8, wherein the event table categorizes each data change event by event type and an associated user account.

11. The at least one non-transitory machine-readable medium of claim 8, the instructions to process the data change event further comprising instructions that cause the at least one processor to:
aggregate data change events from the event table at predetermined intervals; and
calculate the updated count based on the aggregated data change events.

12. The at least one non-transitory machine-readable medium of claim 8, wherein the UI badge visually indicates to the user a number of unread notices or due payments that reflect current account state.

13. The at least one non-transitory machine-readable medium of claim 8, wherein the real-time database system utilizes a non-relational database configured for high-speed data operations and real-time data retrieval.

14. A method for updating a user interface (UI) badge in a computer application in real-time comprising:
receiving a data change event related to account activity of a user in the computer application;
logging the data change event in an event table stored within a transactional database;
processing the data change event to determine an updated count related to the UI badge;
sending, from a batch process to a message broker, a message containing the updated count, wherein the message broker distributes the message to a real-time database system;
transmitting the updated count from the real-time database system to a user interface, wherein the user interface displays the UI badge; and
displaying, in real-time, the updated count on the UI badge.

15. The method of claim 14, wherein the data change event is generated by the transactional database upon occurrence of an account activity selected from the group consisting of: a payment being made, a bill being received, a notice being read, and a notice being issued.

16. The method of claim 14, wherein the event table categorizes each data change event by event type and an associated user account.

17. The method of claim 14, wherein processing the data change event comprises:
aggregating data change events from the event table at predetermined intervals; and
calculating the updated count based on the aggregated data change events.

18. The method of claim 14, wherein the UI badge visually indicates to the user a number of unread notices or due payments that reflect current account state.

19. The method of claim 14, wherein the message broker is configured to handle bulk volumes of messages and distribute the messages across a distributed system.

20. The method of claim 14, wherein the real-time database system utilizes a non-relational database configured for high-speed data operations and real-time data retrieval.
